(19) United States
(12) Patent Application Publication
(10) Pub. No.: US 2018/0111845 A1
(43) Pub. Date: Apr. 26, 2018

(54) WATER TREATMENT DEVICE, AND METHOD OF OPERATING WATER TREATMENT DEVICE

(71) Applicant: MITSUBISHI HEAVY INDUSTRIES, LTD., Tokyo (JP)

(72) Inventors: Hidemasa KAKIGAMI, Tokyo (JP); Yoshiaki ITO, Tokyo (JP); Katsuhiko YOKOHAMA, Tokyo (JP); Hideo IWAHASHI, Tokyo (JP); Takayoshi HORI, Yokohama-shi (JP); Katsunori MATSUI, Yokohama-shi (JP)

(73) Assignee: Mitsubishi Heavy Industries, Ltd., Tokyo (JP)

(21) Appl. No.: 15/558,707

(22) PCT Filed: Mar. 20, 2015
(86) PCT No.: PCT/JP2015/058460

§ 371 Date: Sep. 15, 2017

(51) Int. Cl. C02F 1/00; B01D 61/02; B01D 61/12; B01D 61/08; C02F 1/44

(52) U.S. Cl. CPC C02F 1/008; B01D 61/025; B01D 61/022; C02F 2103/08; B01D 61/08; C02F 1/441; B01D 2313/18; B01D 61/12

(57) ABSTRACT

A water treatment device includes a primary unit having a plurality of primary elements as reverse osmosis membrane devices disposed in parallel with each other to separate water to be treated into primary condensed water and fresh water; a pump which feeds the water to be treated from the upstream side of the primary unit to the primary unit; a secondary unit having secondary elements which are provided to be fewer in number than the primary elements and separate the primary condensed water into secondary condensed water and fresh water; a sub-element which separates one of the water to be treated and the primary condensed water; and a mode switching unit which switches the sub-element between a primary mode of being used as the primary element in the primary unit and a secondary mode of being used as the secondary element in the secondary unit.

### TECHNICAL FIELD

The present invention relates to a water treatment device and a method of operating the same.

### BACKGROUND ART

As a technique for performing desalination of sea water or purification of industrial water, a water treatment device using a reverse osmosis membrane has been put to practical use. As a specific example thereof, a technique described in the following Patent Literature 1 is known. The membrane treatment device described in Patent Literature 1 has a membrane module bank on an upstream stage side and a membrane module bank on a downstream stage side each having a plurality of membrane modules, and a pump which feeds raw water (water to be treated) to the membrane module bank on the upstream stage side.

In such a device, a target value is previously determined with respect to a ratio of fresh water (fresh water recovery rate) recovered from the water to be treated such as sea water. When the fresh water recovery rate is excessively high, the concentration of salt contained in the condensed water, which is a remaining component from which fresh water has been separated, excessively rises. When condensed water of a high salt concentration is discharged into the environment, there is concern about an increase in an environmental burden. Therefore, for example, when sea water is desalinated, the fresh water recovery rate is set to about 25 to 40%.

On the other hand, when the capability of the reverse osmosis membrane declines with the continuous operation of the device, the fresh water recovery rate relatively decreases. In this case, it is necessary to compensate for the decrease in the fresh water recovery rate by increasing the supply pressure of the water to be treated to the reverse osmosis membrane. When the output of the pump is increased to increase the fresh water recovery rate, the supply pressure of the water to be treated to the reverse osmosis membrane rises. As the pressure of the water to be treated rises, the amount of fresh water separated in the reverse osmosis membrane increases and the fresh water recovery rate starts to increase.

### CITATION LIST

### Patent Literature

### Patent Literature 1

Japanese Unexamined Patent Application, First Publication No. 2013-22544

### SUMMARY OF INVENTION

### Technical Problem

However, as the fresh water recovery rate rises as described above, the amount of condensed water separated from the water to be treated decreases. That is, in the device described in the above-mentioned Patent Literature 1, the amount of condensed water supplied from the membrane module bank on the upstream stage side to the membrane module bank on the downstream stage side decreases. Furthermore, in the device using the reverse osmosis membrane, a lower limit value is set for the amount of condensed water (flow rate) discharged per element. If the amount of condensed water falls below the lower limit value, defects such as scale precipitation occur due to an increase in membrane surface concentration caused by concentration polarization in the membrane module, and there is a possibility that sufficient separation and condensation cannot be performed. Therefore, in the device described in the above-mentioned Patent Literature 1, the fresh water recovery rate becomes limited.

The present invention has been made in view of the above circumstances, and an object thereof is to improve the fresh water recovery rate and the operation rate in the water treatment device.

### Solution to Problem

The present invention includes the following aspects in order to solve the above problem.

According to a first aspect of the present invention, a water treatment device includes a primary unit having a plurality of primary elements as reverse osmosis membrane devices disposed in parallel to each other to separate water to be treated supplied from the upstream side into primary condensed water and fresh water; a pump which feeds the water to be treated from the upstream side of the primary unit to supply the water to be treated to the primary unit; a secondary unit having secondary elements as reverse osmosis membrane devices, the secondary elements being provided in smaller number than the primary elements and disposed in parallel to each other to separate the primary condensed water into secondary condensed water and fresh water; a sub-element provided as a reverse osmosis membrane device which separates one of the water to be treated and the primary condensed water into condensed water and fresh water; and a mode switching unit which switches the sub-element between a primary mode of being used as the primary element in the primary unit and a secondary mode of being used as the secondary element in the secondary unit.

According to the above configuration, when the output of the pump is increased, the ratio (fresh water recovery rate) of the fresh water collected from the secondary unit to the deposition of the water to be treated increases. When the fresh water recovery rate increases, the amount of primary condensed water flowing into one of the secondary elements decreases in the secondary unit.

Here, in the reverse osmosis membrane device such as the primary element and the secondary element, the lower limit value is set for the amount of condensed water to be discharged. In the water treatment device, when the amount of the secondary condensed water decreases as described above, the mode switching unit switches the sub-element from the secondary mode to the primary mode. This allows the sub-element to be used as the primary element. The water to be treated guided to the sub-element in the primary mode is separated into the primary condensed water and the fresh water.

Therefore, by switching the sub-element to the primary mode, the number of primary elements in the primary unit substantially increases, and the number of secondary elements in the secondary unit decreases. Thus, a sufficient amount of secondary condensed water can be guided to each secondary element of the secondary unit.

According to a second aspect of the present invention, in the water treatment device according to the first aspect, the sub-element forms one of the secondary elements in the secondary unit, and the mode switching unit includes a sub-distribution line which guides water to be treated from a section between the pump and the primary unit toward the sub-element; a first valve provided on the sub-distribution line; a sub-water collection line which guides the condensed water separated by the sub-element to the secondary unit as the primary condensed water; a second valve provided on the sub-water collecting line; a first switching valve capable of stopping discharge of fresh water from the sub-element; a second switching valve capable of stopping discharge of the condensed water from the sub-element; and a third switching valve capable of stopping the supply of the primary condensed water from the secondary unit to the sub-element.

According to the above configuration, by closing each of the first switching valve, the second switching valve, and the third switching valve, it is possible to separate the secondary element as the sub-element from the secondary unit. After separating the sub-element, by opening each of the first valve and the second valve, the sub-distribution line and the sub-water collection line are opened. Thereby, after the water to be treated is guided to the sub-element from the upstream side of the primary unit, the primary condensed water and the fresh water are generated via reverse osmosis in the sub-element. The primary condensed water is recovered by the sub-water collection line. In particular, these first and second valves can be opened and closed during operation of the device. Thus, it is possible to allow water to flow through the sub-element without stopping the water treatment device. In other words, it is possible to switch modes without lowering the operation rate of the water treatment device.

According to a third aspect of the present invention, the water treatment device according to the second aspect may further include a reflux line which refluxes part of the fresh water separated by the secondary unit to the upstream side of the pump; a reflux pump provided on the reflux line to feed the fresh water; and a reflux valve provided on the reflux line to regulate a flow state of the fresh water.

According to the above configuration, part of the fresh water separated by the secondary unit can be refluxed to the upstream side of the pump as the water to be treated after being extracted by the reflux line. Accordingly, even when the amount of condensed water of the water to be treated with respect to the primary unit decreases, the reduction of the water to be treated can be compensated for by the reflux of the fresh water.

According to a fourth aspect of the present invention, the water treatment device according to any one of the above aspects may further include a measuring unit which measures a characteristic value of at least one of the water to be treated, the primary condensed water, the secondary condensed water, and the fresh water; and a control unit which controls switching between the primary mode and the secondary mode of the sub-element using the mode switching unit, on the basis of a comparison between a Langelier saturation index obtained from the characteristic value and a predetermined reference value.

According to a fifth aspect of the present invention, in the water treatment device according to the fourth aspect, the characteristic value may be a temperature or electric conductivity in at least one of the water to be treated, the primary condensed water, the secondary condensed water, and the fresh water, and the control unit may include a calculating unit which calculates the Langelier saturation index on the basis of the temperature or the electric conductivity.

According to the above configuration, it is possible to maximize the fresh water recovery rate of the water treatment device depending on the quality of water in at least one of the water to be treated, the primary condensed water, the secondary condensed water, and the fresh water. In particular, by providing the measuring unit and the control unit, the capability of the water treatment device against a change in water quality due to seasonal variations or the like can be autonomously adjusted, and thus it is possible to flexibly respond to the change.

According to a sixth aspect of the present invention, there is provided a method of operating the water treatment device when the water treatment device according to the second or third aspect is switched from the secondary mode to the primary mode, the method including: closing the first switching valve to stop discharge of fresh water from the sub-element; closing the second switching valve to stop discharge of the condensed water from the sub-element; closing the third switching valve to stop supply of the primary condensed water from the secondary unit to the sub-element; opening the first valve to guide the water to be treated to the sub-element through the sub-distribution line; and opening the second valve while opening the first valve to guide the condensed water separated by the sub-element through the sub-water collection line to the secondary unit as the primary condensed water.

According to the above method, by first closing each of the first switching valve, the second switching valve, and the third switching valve in the mode switching unit, discharge of fresh water, discharge of condensed water and supply of condensed water from the upstream side to the sub-element are stopped. As a result, the sub-element is substantially separated from the secondary unit. In this state, by sequentially opening the first valve and the second valve, the sub-distribution line and the sub-water collection line are opened, and the water to be treated is guided to the sub-element. That is, the sub-element functions as one of the primary elements. Thereafter, the water to be treated guided to the sub-element is separated into primary condensed water and fresh water.

In particular, the first and second valves are capable of being opened and closed during operation of the device. As a result, it is possible to allow water to flow through the sub-element without stopping the water treatment device. In other words, it is possible to switch modes without lowering the operation rate of the water treatment device.

### Advantageous Effects of Invention

According to the water treatment device and the method of operating the water treatment device of the present invention, it is possible to improve the fresh water recovery rate and the operation rate.

### BRIEF DESCRIPTION OF DRAWINGS

FIG. 1 is a system diagram illustrating a water treatment device according to a first embodiment of the present invention.

FIG. 2 is a process chart illustrating a method of operating the water treatment device according to the first embodiment of the present invention.

FIG. 3 is a system diagram illustrating a water treatment device according to a second embodiment of the present invention.

FIG. 4 is a process chart illustrating the method of operating the water treatment device according to the second embodiment of the present invention.

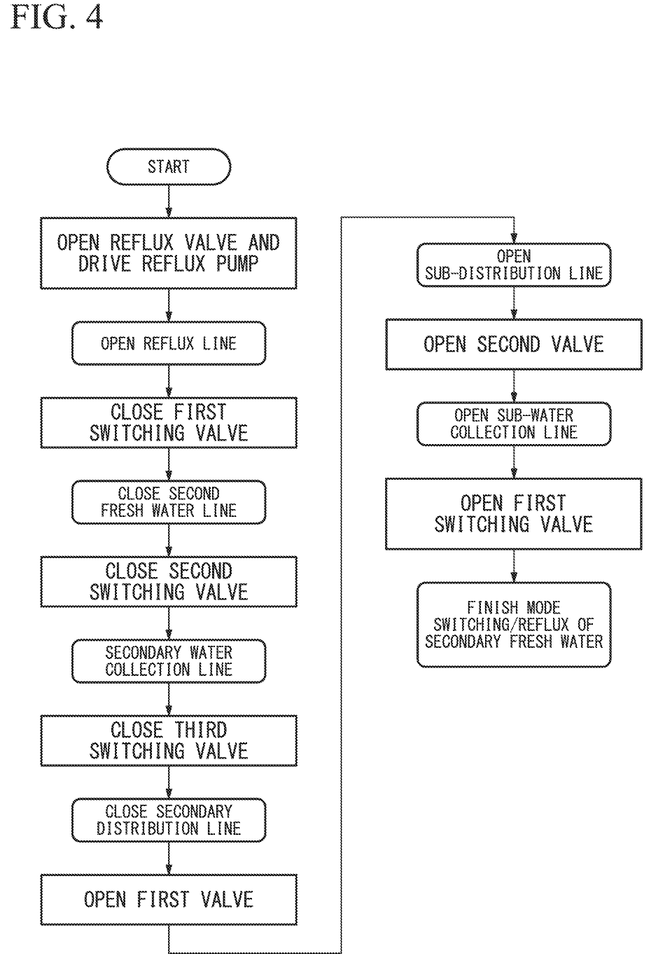

FIG. 5 is a system diagram illustrating a water treatment device according to a modified example of the present invention.

### DESCRIPTION OF EMBODIMENTS

### First Embodiment

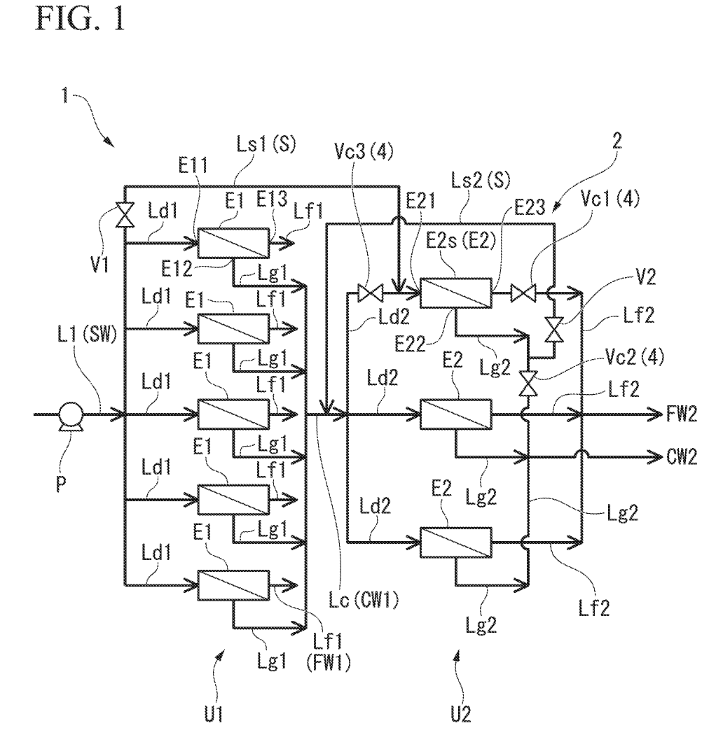

A first embodiment of the present invention will be described with reference to the drawings. As illustrated in FIG. 1, a water treatment device 1 according to the present embodiment includes a water intake line L1 through which water to be treated SW flows, a pump P which feeds the water to be treated SW from the upstream to the downstream of the water intake line L1, a primary unit U1 and a secondary unit U2 having a plurality of reverse osmosis membrane devices (a primary element E1, and a secondary element E2), and a connection line Lc which connects the primary unit U1 and secondary unit U2 to each other. Furthermore, the water treatment device 1 includes a sub-element E2s as a reverse osmosis membrane device to which one of the water to be treated SW and the primary condensed water CW1 is introduced, and a mode switching unit 2 which switches a use state (mode) of the sub-element E2s.

The water intake line L1 is a flow path which guides the water to be treated SW supplied from the outside to the water treatment device 1. On the upstream side of the water intake line L1, for example, a pretreatment device (not illustrated) is provided. In the pretreatment device, addition of an oxidizing agent for suppressing organisms contained in sea water from adhering to the device, or a flocculant for aggregating fine particles, colloids and the like, and adjustment of pH and the like are performed. More specifically, hypochlorous acid or the like is preferably used as the oxidizing agent. Further, an inorganic flocculant such as ferric chloride or a polymer flocculant such as PAC is used as the flocculant. The suspension agglomerated by the flocculant is removed by a sand filter.

The water to be treated SW subjected to the pretreatment as described above is fed from the upstream side toward the downstream side in the water intake line L1, by the pump P provided on the water intake line L1.

The primary unit U1 and the secondary unit U2 are devices for separating and condensing the water to be treated SW guided by the water intake line L1 by reverse osmosis. The primary unit U1 includes a plurality of primary elements E1 disposed in parallel to each other, a primary distribution line Ld1 which distributes the water to be treated SW in the water intake line L1 to the plurality of primary elements E1, and a primary water collection line Lg1 and a primary fresh water line Lf1 through which the primary condensed water CW1 and the fresh water (primary fresh water FW1) discharged from the primary element E1 flow, respectively.

The primary element E1 is a reverse osmosis membrane device including a reverse osmosis membrane (RO membrane) such as a hollow fiber membrane or a spiral membrane therein. Each of the primary elements E1 mainly includes an exterior member called a vessel, and a reverse osmosis membrane disposed inside the vessel. Furthermore, a primary flow inlet E11 connected to the distribution line, and a primary water collection port E12 and a primary fresh water collection port E13 connected to the primary water collection line Lg1 and the primary fresh water line Lf1, respectively, are provided in the vessel.

The primary unit U1 is configured by disposing the primary elements E1 in parallel to each other. As an example, in the present embodiment, five primary elements E1 are disposed in parallel. More specifically, the downstream end portion of the water intake line L1 and the primary flow inlet E11 of each primary element E1 are connected to each other by the distribution line. Further, the primary water collection line Lg1 connects the primary water collection port E12 of each primary element E1 and the upstream end portion of the connection line Lc (to be described later) to each other. The primary fresh water line Lf1 is a flow path for discharging and collecting fresh water separated in each primary element E1 to the outside. On the downstream side of the primary fresh water line Lf1, a tank for storing the recovered fresh water or facilities for performing further filtering etc. are connected (neither is illustrated). With the above configuration, the five primary elements E1 are in parallel to each other.

The number of primary elements E1 is not limited to five, but may be four or less, or six or more, as long as the number is larger than the number of secondary elements E2 to be described later.

The secondary unit U2 is a device for further separating and condensing the primary condensed water CW1 generated in the primary unit U1 by the same configuration as the primary unit U1. More specifically, the secondary unit U2 has a plurality of secondary elements E2 disposed in parallel to each other, a second distribution line Ld2 which distributes the primary condensed water CW1 generated in the primary unit U1 to the plurality of secondary elements E2, and a secondary water collection line Lg2 and a secondary fresh water line Lf2 through which the secondary condensed water CW2 discharged from the secondary element E2 and the fresh water (secondary fresh water FW2) flow, respectively.

The secondary element E2 is a reverse osmosis membrane device having the same configuration and capability as the above-mentioned primary element E1, but they are distinguished in the following description. In the vessel of the secondary element E2, a secondary flow inlet E21 connected to the secondary distribution line Ld2, and a secondary water collection port E22 and a secondary fresh water collection port E23 connected to each of the secondary water collection line Lg2 and the secondary fresh water line Lf2 are provided.

Similarly to the primary unit U1, the secondary unit U2 is configured by disposing a plurality of secondary elements E2 in parallel to each other. The number of secondary elements E2 in the secondary unit U2 is set to be smaller than the number of primary elements E1 in the primary unit U1. In the present embodiment, three secondary elements E2 are provided in the secondary unit U2. However, the number of secondary elements E2 is not limited to three, and may be two, or four or more, as long as the number of the secondary elements E2 is smaller than the number of primary elements E1.

In the present embodiment, one secondary element E2 among these three secondary elements E2 is the aforementioned sub-element E2s. A sub-line system S is provided as a system for supplying and discharging condensed water and fresh water to and from the sub-element E2s. More specifically, as the sub-line system S, a sub-distribution line Ls1 for guiding the water to be treated SW from the water intake line L1, and a sub-water collection line Ls2 for recovering the condensed water generated in the sub-element E2 are connected to the sub-element E2s.

The sub-distribution line Ls1 is a flow path that connects a section between the pump P on the water intake line L1 and the primary unit U1 with the secondary distribution line Ld2 in the secondary element E2 as the sub-element E2s.

The sub-water collection line Ls2 is a flow path which connects the secondary water collection line Lg2 of the secondary element E2 as the sub-element E2s and a flow path between the primary unit U1 and the secondary unit U2 (connection line Lc to be described later).

On the sub-distribution line Ls1 and the sub-water collection line Ls2, a valve device for adjusting the flow state of each flow path is provided. The valve device provided on the sub-distribution line Ls1 is a first valve V1. The valve device provided on the sub-water collection line Ls2 is the second valve V2.

The sub-line system S thus configured forms a part of a mode switching unit 2 to be described later.

The connection line Lc connects the downstream side of the primary unit U1 and the upstream side of the secondary unit U2 (including the sub-element E2s). More specifically, the connection line Lc connects the downstream end portion of each primary water collection line Lg1 in the primary unit U1 and the upstream end portion of each secondary distribution line Ld2 in the secondary unit U2.

Thereby, as the primary condensed water CW1 generated in the primary unit U1 flows in the order of the primary water collection line Lg1, the connection line Lc, and the secondary distribution line Ld2, the primary condensed water CW1 is distributed to each secondary element E2 of the secondary unit U2 including the sub-element E2s. In the secondary element E2, the primary condensed water CW1 is further separated and condensed to generate fresh water (secondary fresh water FW2) and secondary condensed water CW2 as the remaining components except the secondary fresh water FW2. Fresh water is recovered through the secondary fresh water line Lf2. The secondary condensed water CW2 is recovered through the secondary water collection line Lg2 and then discharged to the outside after undergoing post-treatment or the like at an external facility (not illustrated).

Furthermore, the sub-element E2s is capable of switching modes between a primary mode used as one of the primary elements E1 and a secondary mode used as one of the secondary elements E2. Such mode switching is performed by the mode switching unit 2. The mode switching unit 2 includes the sub-line system S and a dividing unit 4. The dividing unit 4 has three valve devices. The valve devices are defined as a first switching valve Vc1, a second switching valve Vc2, and a third switching valve Vc3.

The first switching valve Vc1 is provided on the secondary fresh water line Lf2 connected to the secondary element E2 as the sub-element E2s. By opening and closing the first switching valve Vc1, the flow state of the fresh water (the secondary fresh water FW2) in the secondary fresh water line Lf2 is switched. For example, by closing the first switching valve Vc1, the flow of the secondary fresh water FW2 can be stopped.

The second switching valve Vc2 is provided on the secondary water collection line Lg2 connected to the secondary element E2 as the sub-element E2s. By opening and closing the second switching valve Vc2, the flow state of the secondary condensed water CW2 in the secondary water collection line Lg2 is switched. For example, by closing the second switching valve Vc2, the flow of the secondary condensed water CW2 can be stopped.

The third switching valve Vc3 is provided on the secondary distribution line Ld2 connected to the secondary element E2 as the sub-element E2s. By opening and closing the third switching valve Vc3, the flow state of the primary condensed water CW1 in the secondary distribution line Ld2 is switched. For example, by closing the third switching valve Vc3, the circulation of the primary condensed water CW1 can be stopped.

By closing the first switching valve Vc1, the second switching valve Vc2, and the third switching valve Vc3, the respective lines (the secondary fresh water line Lf2, the secondary water collection line Lg2, and the secondary distribution line Ld2) are closed. Thereby, the supply of the primary condensed water CW1 to the sub-element E2s and the discharge of the secondary fresh water FW2 and the secondary condensed water CW2 are stopped and processing is disabled. That is, the sub-element E2s is separated from the system.

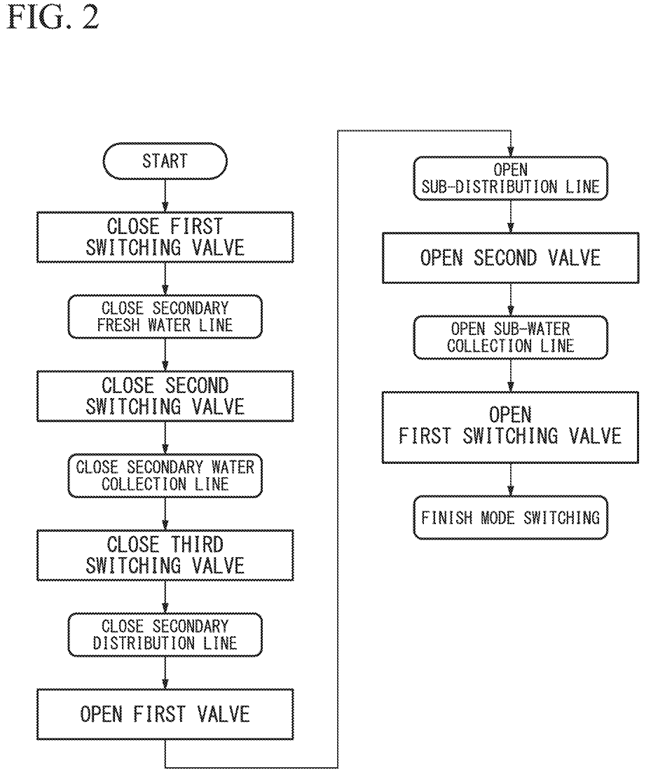

Next, a method of operating the water treatment device 1 configured as described above will be described with reference to FIG. 1 and FIG. 2.

First, a state in which the sub-element E2s is used as one of the secondary elements E2 (secondary mode) will be described. In the case of the secondary mode, in the mode switching unit 2, each valve device (the first switching valve Vc1, the second switching valve Vc2, and the third switching valve Vc3) in the dividing unit 4 is opened. On the other hand, each of the valve devices (the first valve V1 and the second valve V2) provided in the sub-line system S is in a closed state. In the water treatment device 1, the secondary mode is set to a normal operation state.

By driving the pump P under the above secondary mode, the water to be treated SW is guided to the primary unit U1 via the water intake line L1. The water to be treated SW pressurized by the pump P passes through the reverse osmosis membrane of each primary element E1 in a high-pressure state.

In the primary unit U1, reverse osmosis with respect to the water to be treated SW is performed in each primary element E1. As a result, in the primary element E1, the primary condensed water CW1 in which salt or the like in the water to be treated SW is condensed, and the primary fresh water FW1 as remaining components except the primary condensed water CW1 (fresh water) are generated. More specifically, the fresh water component of the water to be treated SW is transmitted through the reverse osmosis membrane and reaches the downstream side to become the primary fresh water FW1. As the primary fresh water FW1 is transmitted to the downstream side, salt contained in the water to be treated SW is condensed on the upstream side of the reverse osmosis membrane. Thereby, the primary condensed water CW1 is generated on the upstream side of the reverse osmosis membrane. At the downstream side of the reverse osmosis membrane, the pressure of the primary fresh water FW1 becomes smaller than the pressure of the water to be treated SW.

The primary fresh water FW1 is recovered to the outside via the primary fresh water line Lf1. The primary condensed water CW1 is collected in the primary water collection line Lg1 and then flows into the secondary unit U2 on the downstream side via the connection line Lc. In the secondary unit U2, the primary condensed water CW1 flowing in via the connection line Lc is distributed to each secondary element E2 by the secondary distribution line Ld2. As described above, since the third switching valve Vc3 in the mode switching unit 2 is opened, the primary condensed water CW1 is also distributed to the sub-element E2s as the secondary element E2.

Similarly to the primary element E1, in the secondary element E2, separation of fresh water from the primary condensed water CW1 and condensation of salts are performed. That is, the secondary fresh water FW2 which is a fresh water component in the primary condensed water CW1, and the secondary condensed water CW2 which is the remaining component except the secondary fresh water FW2 are generated.

The secondary fresh water FW2 is recovered to the outside by the Secondary fresh water line Lf2. The secondary condensed water CW2 is collected in the secondary water collection line Lg2 and then discharged into the external environment. By continuously performing the above operations, the water to be treated SW (sea water) is desalinated.

In the water treatment device 1 as described above, a target value is predetermined with respect to a volume ratio of the fresh water recovered from the water to be treated SW (fresh water recovery rate). For example, when sea water is desalinated, the fresh water recovery rate is set to about 25 to 40%. However, when the capability of the reverse osmosis membrane deteriorates with the continuous operation of the device, the fresh water recovery rate relatively decreases and may fall below the target value. In this case, by increasing the output of the pump P, the supply pressure of the water to be treated SW to the reverse osmosis membrane increases. As the pressure of the water to be treated SW increases, the amount of fresh water separated in the reverse osmosis membrane increases, and the fresh water recovery rate starts to rise.

However, as the fresh water recovery rate rises as described above, the amount of the secondary condensed water CW2 separated from the water to be treated SW decreases. Here, in the device using the reverse osmosis membrane, the lower limit value is set for the amount (flow rate) of condensed water to be discharged. When the amount of the condensed water falls below the lower limit value, defects such as scale precipitation occur due to an increase in membrane surface concentration caused by concentration polarization in the membrane module, and there is a possibility that sufficient separation and concentration cannot not be performed.

Therefore, in the water treatment device 1 according to the present embodiment, since the secondary element E2 serving as the sub-element E2s is used as the primary element E1 (switched to the primary mode) by the mode switching unit 2, it is possible to substantially reduce the number of secondary elements E2.

The operation at the time of such mode switching will be described in detail below. In order to switch the sub-element E2s in the secondary mode to the primary mode, the sub-element E2s is first divided from the secondary unit U2 by the dividing unit 4.

More specifically, as illustrated in FIG. 2, as a method of operating the water treatment device 1 for switching the mode of the sub-element E2s, a step of closing the first switching valve Vc1, a step of closing the second switching valve Vc2, and the step of closing the third switching valve Vc3 are performed in the aforementioned order.

By closing the first switching valve Vc1, the flow of the secondary fresh water FW2 in the secondary fresh water line Lf2 (fresh water line) is stopped. Subsequently, by closing the second switching valve Vc2 after closing the first switching valve Vc1, the flow of the secondary condensed water CW2 in the secondary water collection line Lg2 (secondary condensed water CW2 line) is stopped. Next, by stopping the third switching valve Vc3 after closing the second switching valve Vc2, the secondary water collection line Lg2 is closed. Thereby, the supply of the primary condensed water CW1 using the secondary water collection line Lg2 is stopped.

As a result, the secondary element E2 as the sub-element E2s is separated (divided) from the secondary element E2 in the secondary unit U2. At this time, the primary condensed water CW1 stays in the sub-element E2s.

Next, the first valve V1 on the sub-distribution line Ls1 is opened. Thereby, part of the water to be treated SW flowing through the water intake line L1 is guided to the sub-element E2s through the sub-distribution line Ls1. That is, similarly to other primary elements E1, since the water to be treated SW is guided, the sub-element E2s starts functioning as the primary element E1. As a result, the water to be treated SW is separated into the condensed water as the primary condensed water CW1 and the fresh water as the primary fresh water FW1 in the sub-element E2s.

Furthermore, in this state, the second valve V2 on the sub-water collection line Ls2 is opened. As a result, the primary condensed water CW1 generated in the sub-element E2s is recovered by the sub-water collection line Ls2. Since the sub-water collection line Ls2 is connected on the connection line Lc as described above, the primary condensed water CW1 generated in the sub-element E2s is guided to the secondary unit U2 via the connection line Lc. In the secondary unit U2, the primary condensed water CW1 is separated by the secondary element E2 other than the sub-element E2s, and then collected as the secondary condensed water CW2 and the secondary fresh water FW2.

Subsequently, the first switching valve Vc1 is opened again. As a result, the fresh water generated in the sub-element E2s is recovered by the secondary fresh water line Lf2.

As described above, in the water treatment device 1 according to the present embodiment, when the output of the pump P is increased, the ratio of the fresh water recovered from the secondary unit U2 to the deposition of the water to be treated SW (fresh water recovery rate) increases. When the fresh water recovery rate increases, the amount of the secondary condensed water CW2 discharged from each of the secondary elements E2 in the secondary unit U2 decreases.

On the other hand, in the reverse osmosis membrane device, the lower limit value is set for the amount of condensed water discharged from each element. Therefore, the water treatment device 1 according to the present embodiment adopts a configuration in which, when the amount of the secondary condensed water CW2 decreases as described above, by switching the mode of the sub-element E2s by the mode switching unit 2, the sub-element E2s is used as one of the primary elements E1.

More specifically, in the water treatment device 1, when initially operated in the secondary mode, the number of primary elements E1 in the primary unit U1 is five, and the number of secondary elements E2 in the secondary unit U2 is three.

On the other hand, when the mode is switched to the primary mode, the secondary element E2 serving as the sub-element E2s is functionally incorporated in the primary unit U1 and functions as one of the primary elements E1. That is, the primary unit U1 in this state has six primary elements E1, and the secondary unit U2 has two secondary elements E2.

As described above, in the primary unit U1, it is possible to generate more fresh water than in the secondary mode. In other words, the maximum value of the fresh water recovery rate can be improved. On the other hand, the generated amount of primary condensed water CW1 decreases with an increase in the fresh water recovery rate. Here, in the primary mode, the number of secondary elements E2 in the secondary unit U2 decreases as compared with the case of the secondary mode. Therefore, even when the fresh water recovery rate increases and the condensed water amount decreases, it is possible to increase the amount of the secondary condensed water CW2 discharged from one of the remaining secondary elements E2.

Furthermore, switching of the mode as described above can be easily performed by simply operating each valve device (the first switching valve Vc1, the second switching valve Vc2, the third switching valve Vc3, the first valve V1, and the second valve V2) in the mode switching unit 2. In addition, the valve devices can be opened and closed during water flow (operation) of the water treatment device 1. Therefore, in the water treatment device 1 according to the present embodiment, it is possible to switch the use state of the sub-element E2s without stopping the operation. This makes it possible to improve the maximum value of the fresh water recovery rate without lowering the operation rate of the water treatment device 1.

Here, for example, in order to increase the flow rate of condensed water for each secondary element E2, when the inflow of condensed water to a part of the secondary elements E2 is blocked (plugged), it is necessary to stop the water flow to the water treatment device 1 (stop the operation) to dispose the plug. However, according to the above configuration, since the operation can be performed during the operation of the water treatment device 1, it is possible to reduce the possibility of a decrease in the operation rate of the water treatment device 1 by the operation.

The first embodiment of the present invention has been described with reference to the drawings. However, the above configuration is merely an example, and various design changes can be made.

### Second Embodiment

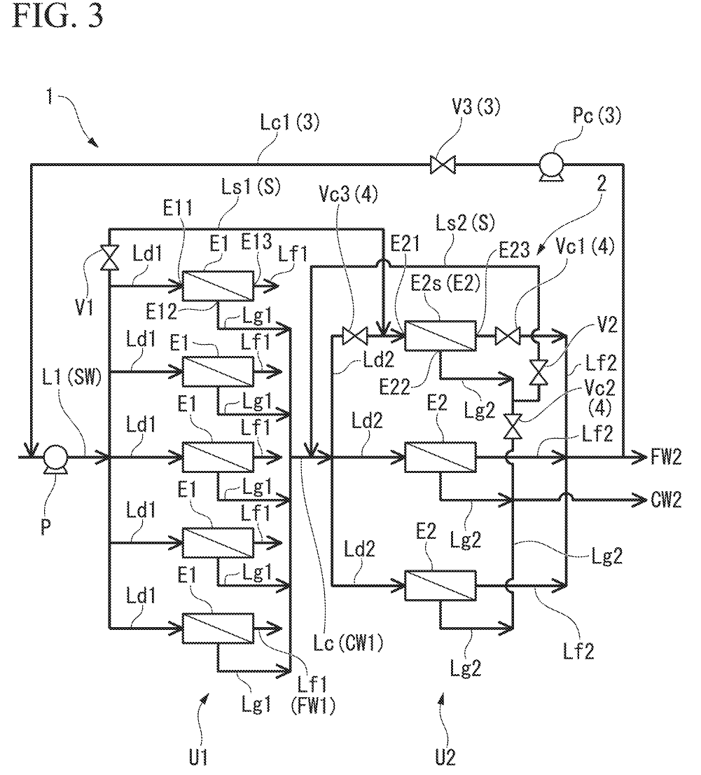

Next, a second embodiment of the present invention will be described with reference to FIG. 3. The same configurations as in the aforementioned first embodiment are denoted by the same reference numerals, and a detailed description thereof will not be provided. As illustrated in FIG. 3, in the water treatment device 1 according to the present embodiment, a reflux unit 3 is provided in addition to the pump P, the primary unit U1, the connection line Lc, the secondary unit U2, and the mode switching unit 2.

The reflux unit 3 includes a reflux line Lc1 which refluxes fresh water as the secondary fresh water FW2 to the upstream side of the primary unit U1, a reflux pump Pc which feeds the secondary fresh water FW2 on the reflux line Lc1 in one direction, and a reflux valve V3 provided on the reflux line Lc1.

In the present embodiment, the reflux line Lc1 connects a region on the secondary fresh water line Lf2 of the downstream side of the first switching valve Vc1 and a region on the water intake line L1 of the upstream side of the pump P. By driving the reflux pump Pc, the secondary fresh water FW2 extracted by the reflux line Lc1 is fed toward the water intake line L1 side. The reflux valve V3 is a valve device that switches the flow state of the secondary fresh water FW2 in the reflux line Lc1.

A method of operating the water treatment device 1 configured as described above will be described. In operating the water treatment device 1, first, a step of opening the aforementioned reflux valve V3 and a step of driving the reflux pump Pc are performed in order. Thereby, a part of the secondary fresh water FW2 flowing through the secondary fresh water line Lf2 is extracted by the reflux line and then supplied into the water intake line L1. As the fresh water is supplied to the water intake line L1 in this manner, the amount of water to be treated SW in the water intake line L1 increases. That is, more amount of condensed water is guided to each primary element E1 in the primary unit U1.

Therefore, even when the supply amount of the condensed water (water to be treated SW) to the primary unit U1 decreases and falls below the lower limit value of the condensed water amount for the primary element E1, by refluxing the secondary fresh water FW2 using the reflux unit 3, it is possible to compensate for the decrease in the amount of condensed water.

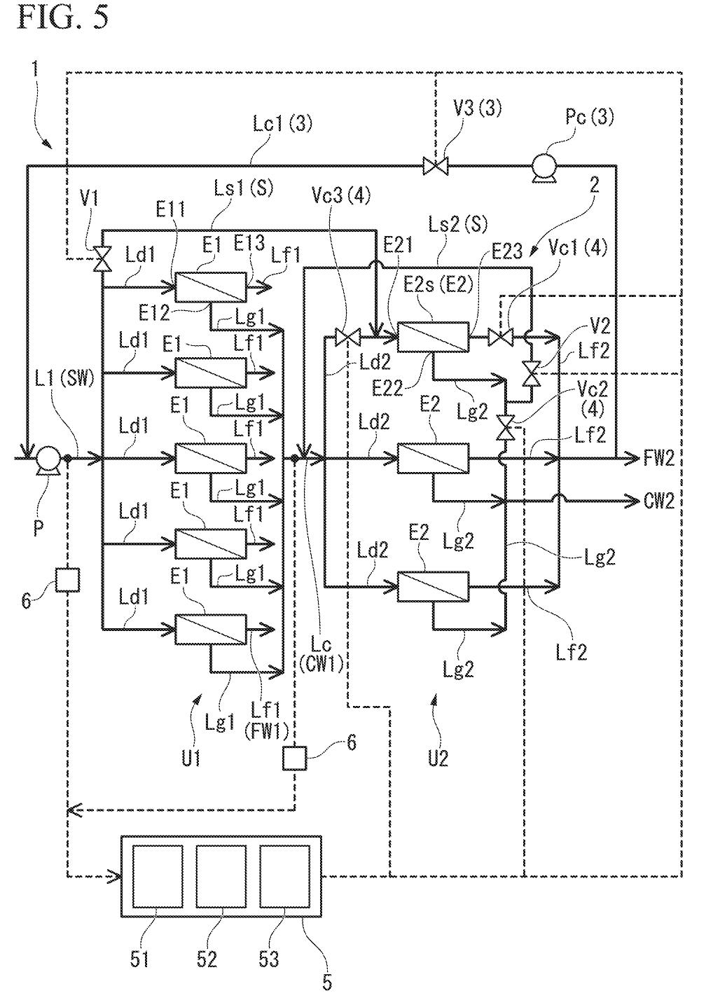

Furthermore, the operation of the mode switching unit 2 and the reflux unit 3 in each of the above embodiments may be performed by an operator, or may be performed by the control unit 5 illustrated in FIG. 5. In the case of using the control unit 5, by providing the measuring unit 6 on the water intake line L1 and on the connection line Lc, characteristic values of water (the water to be treated SW, the primary condensed water CW1, the secondary condensed water CW2, the primary fresh water FW1, and the secondary fresh water FW2) in each line are measured. On the basis of the characteristic values, the control unit 5 controls opening and closing of each valve device of the mode switching unit 2.

The control unit 5 has a calculating unit 51 that performs calculations on the basis of various characteristic values obtained by the measuring unit 6, a determining unit 52 that determines necessity of operation of the mode switching unit 2 on the basis of a calculation result of the calculating unit 51, and a signal generating unit 53 that instructs the degree of opening of each valve device (the first switching valve Vc1, the second switching valve Vc2, the third switching valve Vc3, the first valve V1, the second valve V2, and the reflux valve V3) of the mode switching unit 2 and the reflux unit 3 as an electric signal on the basis of the determination of the determining unit 52.

In the case of adopting the above configuration, the measuring unit 6 continuously measures characteristic values such as electric conductivity of water, temperature, Langelier saturation index (LSI), and the like. The determining unit 52 in the control unit 5 compares these characteristic values with a predetermined reference value or reference range. When the reference value or the reference range is satisfied, the determining unit 52 determines that the fresh water recovery rate can be increased, and the mode switching of the sub-element E2s by the mode switching unit 2 (switching from the secondary mode to the primary mode) or reflux of the secondary fresh water FW2 by the reflux unit 3 is performed.

Further, when using the LSI as an indicator, “the case in which the reference value or the reference range is satisfied” corresponds to a case in which the LSI is smaller than the reference value (e.g., smaller than 0). Further, the determination as to whether or not the fresh water recovery rate can be increased is usually performed by checking the presence or absence of scale precipitation of the element using LSI, but the same determination may be made on the basis of the electric conductivity and temperature.

Generally, the value of LSI depends on each value of electric conductivity and temperature of water to be measured. Furthermore, the electrical conductivity is determined by the dissolved salt concentration in water (i.e., the concentration of salt dissolved in the ion state as an electrolyte). Further, as the temperature of water increases by 1° C., the value of LSI increases by approximately 1.5×10⁻².

Therefore, it is also possible to provide a configuration in which, after the measuring unit 6 measures the electric conductivity and the temperature, the calculating unit 51 in the control unit 5 calculates the LSI-converted value by performing calculation on the basis of the characteristic values. Even in this case, the determining unit 52 of the control unit 5 determines whether or not the fresh water recovery rate can be increased on the basis of the LSI-converted value.

That is, when using the reference range of the electric conductivity or temperature corresponding to the case in which the LSI is smaller than the reference value, the determining unit 52 determines that the fresh water recovery rate can be increased, and the mode switching of the sub-element E2s by the mode switching unit 2 and the reflux using the reflux unit 3 are performed.

According to such a configuration, it is possible to autonomously maximize the fresh water recovery rate in accordance with the water quality of the water to be treated SW. In particular, the capability of the water treatment device 1 can flexibly respond to changes in water quality due to seasonal variations or the like.

### INDUSTRIAL APPLICABILITY

According to the water treatment device 1 and the method of operating the water treatment device 1 described above, it is possible to improve the fresh water recovery rate and the operation rate.

### REFERENCE SIGNS LIST

1 Water treatment device
2 Mode switching unit
3 Reflux unit
4 Dividing unit
5 Control unit
51 Calculating unit
52 Determining unit
53 Signal generating unit
6 Measuring unit
CW1 Primary condensed water
CW2 Secondary condensed water
E1 Primary element
E11 Primary flow inlet
E12 Primary water collection port
E13 Primary fresh water collection port
E2 Secondary element
E21 Secondary flow inlet
E22 Secondary water collection port
E23 Secondary fresh water collection port
E2s Sub-element
FW1 Primary fresh water
FW2 Secondary fresh water
L1 Water intake line
Lc Connection line
Lc1 Reflux line
Ld1 Primary distribution line
Ld2 Secondary distribution line
Lf1 Primary fresh water line
Lf2 Secondary fresh water line
Lg1 Primary water collection line
Lg2 Secondary water collection line
Ls1 Sub-distribution line
Ls2 Sub-water collection line
P Pump
Pc Reflux pump
S Sub-line system
SW Water to be treated
U1 Primary unit
U2 Secondary unit
V1 First valve
V2 Second valve
V3 Reflux valve
Vc1 First switching valve
Vc2 Second switching valve
Vc3 Third switching valve

1-6. (canceled)

7. A water treatment device comprising:
a primary unit having a plurality of primary elements as reverse osmosis membrane devices disposed in parallel to each other to separate water to be treated supplied from the upstream side into primary condensed water and fresh water;
a pump which feeds the water to be treated from the upstream side of the primary unit to supply the water to be treated to the primary unit;
a secondary unit having secondary elements as reverse osmosis membrane devices, the secondary elements being provided in smaller number than the primary elements and disposed in parallel to each other to separate the primary condensed water into secondary condensed water and fresh water;
a sub-element provided as a reverse osmosis membrane device which separates one of the water to be treated and the primary condensed water into condensed water and fresh water; and
a mode switching unit which switches the sub-element between a primary mode of being used as the primary element in the primary unit and a secondary mode of being used as the secondary element in the secondary unit,
wherein the sub-element forms one of the secondary elements in the secondary unit, and
wherein the mode switching unit comprises:
a sub-distribution line which guides water to be treated from a section between the pump and the primary unit toward the sub-element;
a first valve provided on the sub-distribution line;
a sub-water collection line which guides the condensed water separated by the sub-element to the secondary unit as the primary condensed water;
a second valve provided on the sub-water collection line;
a first switching valve capable of stopping discharge of fresh water from the sub-element;
a second switching valve capable of stopping discharge of the condensed water from the sub-element; and
a third switching valve capable of stopping the supply of the primary condensed water from the primary unit to the sub-element.

8. The water treatment device according to claim 7, further comprising:
a reflux line which refluxes a part of the fresh water separated by the secondary unit to the upstream side of the pump;
a reflux pump provided on the reflux line to feed the fresh water; and
a reflux valve provided on the reflux line to regulate a circulation state of the fresh water.

9. The water treatment device according to claim 7, further comprising:
a measuring unit which measures a characteristic value of at least one of the water to be treated, the primary condensed water, the secondary condensed water, and the fresh water; and
a control unit which controls switching between the primary mode and the secondary mode of the sub-element using the mode switching unit, on the basis of a comparison between a Langelier saturation index obtained from the characteristic value and a predetermined reference value.

10. The water treatment device according to claim 9, wherein the characteristic value is a temperature or electric conductivity in at least one of the water to be treated, the primary condensed water, the secondary condensed water, and the fresh water, and
the control unit includes a calculating unit which calculates the Langelier saturation index on the basis of the temperature or the electric conductivity.

11. A method of operating the water treatment device when the water treatment device according to claim 7 is switched from the secondary mode to the primary mode, the method comprising:
closing the first switching valve to stop discharge of fresh water from the sub-element;
closing the second switching valve to stop discharge of the condensed water from the sub-element;
closing the third switching valve to stop supply of the primary condensed water from the primary unit to the sub-element;
opening the first valve to guide the water to be treated to the sub-element through the sub-distribution line; and
opening the second valve while opening the first valve to guide the condensed water separated by the sub-element through the sub-water collection line to the secondary unit as the primary condensed water.

12. The water treatment device according to claim 8, further comprising:
a measuring unit which measures a characteristic value of at least one of the water to be treated, the primary condensed water, the secondary condensed water, and the fresh water; and
a control unit which controls switching between the primary mode and the secondary mode of the sub-element using the mode switching unit, on the basis of a comparison between a Langelier saturation index obtained from the characteristic value and a predetermined reference value.

13. The water treatment device according to claim 12, wherein the characteristic value is a temperature or electric conductivity in at least one of the water to be treated, the primary condensed water, the secondary condensed water, and the fresh water, and
the control unit includes a calculating unit which calculates the Langelier saturation index on the basis of the temperature or the electric conductivity.

14. A method of operating the water treatment device when the water treatment device according to claim 8 is switched from the secondary mode to the primary mode, the method comprising:
closing the first switching valve to stop discharge of fresh water from the sub-element;
closing the second switching valve to stop discharge of the condensed water from the sub-element;
closing the third switching valve to stop supply of the primary condensed water from the primary unit to the sub-element;
opening the first valve to guide the water to be treated to the sub-element through the sub-distribution line; and
opening the second valve while opening the first valve to guide the condensed water separated by the sub-element through the sub-water collection line to the secondary unit as the primary condensed water.
